(19) United States
(12) Patent Application Publication
(10) Pub. No.: US 2025/0209385 A1
(43) Pub. Date: Jun. 26, 2025

(54) COVARIATE DRIFT DETECTION

(71) Applicant: Sage Global Services Limited, Newcastle upon Tyne (GB)

(72) Inventors: Yu-Cheng TSAI, Redmond, WA (US); Edolfo GARZA-LICUDINE, San Francisco, CA (US)

(73) Assignee: Sage Global Services Limited, Newcastle upon Tyne (GB)

(21) Appl. No.: 18/394,343

(22) Filed: Dec. 22, 2023

(51) Int. Cl. G06N 20/20

(52) U.S. Cl. CPC G06N 20/20

(57) ABSTRACT

A computer implemented method for covariate drift correction in a system that employs an AI model trained on a first training dataset for generating output prediction data. A covariate shift quantification process is applied to input data, including computing a statistical value to quantify the drift in the input data. The statistical value is compared with a predetermined threshold to determine if a covariate shift has occurred. A retraining process is triggered for the AI model in response to a covariate shift occurring. A further training dataset is retrieved based on input data and prediction data after the first training dataset was generated. Candidate training datasets are generated from the further training dataset, by applying a different combination of different temporal windows and different temporal weighting decay rates. The candidate training datasets are evaluated and selected, and the AI model is retained with a selected candidate training dataset.

### TECHNICAL FIELD

The present invention relates to techniques for correcting covariate drift in AI systems.

### BACKGROUND

AI technologies have become integral to a wide array of applications, ranging from data analytics to automation. These systems rely on accurate and consistent data to train models that can make reliable predictions or classifications.

A significant challenge in the field of AI is the issue of data drift, specifically covariate drift. Covariate drift occurs when the distribution of the input data changes over time, leading to a decrease in model performance if not corrected.

The impact of covariate drift is particularly problematic in systems that depend on real-time or near-real-time data. If the drift is not accounted for, the accuracy and reliability of the AI model can be severely compromised.

One specific application where the problem of covariate drift is acute is in the analysis of invoice data for accounting purposes. Here, AI models can be used to automatically categorise invoices according to accounting processing data, such as General Ledger (GL) codes.

However, analysing invoice data comes with a number of challenges. Not only does invoice data vary in format and fields, but it is also susceptible to changes that introduce covariate drift. For instance, the addition of new customers, introduction of new products, or changes in how items are described can all lead to a shift in the distribution of the input data. These variations make invoice data particularly prone to covariate drift, requiring a solution that can adapt to these changes effectively.

Alongside the challenge of covariate drift is the related issue of concept drift. While covariate drift focuses on changes in the distribution of the input data, concept drift deals with alterations in the underlying relationships between the input features and the output predictions, such as GL codes in the case of invoice data. Over time, the optimal model to predict or categorise data may change, requiring not just an adjustment for new types of input data, but also a more fundamental retraining of the model to maintain its accuracy.

### SUMMARY OF THE INVENTION

In accordance with a first aspect of the invention, there is provided a computer implemented method for covariate drift correction in a system that employs an AI model trained on a first training dataset for generating output prediction data. The method comprises the steps of:
a. receiving input data intended for said AI model;
b. applying a covariate shift quantification process to said input data, wherein said covariate shift quantification process comprises computing a statistical value to quantify the drift in said input data relative to said first training dataset;
c. comparing said statistical value with a predetermined threshold;
d. determining that a covariate shift has occurred when said statistical value exceeds said predetermined threshold; and
e. triggering a retraining process for said AI model in response to said determination that a covariate shift has occurred, wherein the retraining process comprises the steps of:
f. retrieving a further training dataset comprising at least training data based on input data and prediction data from operation of the system after the first training dataset was generated;
g. generating from the further training dataset a plurality of candidate training datasets, each generated by applying to the further training dataset a different combination of different temporal windows and different temporal weighting decay rates, wherein each different temporal window specifies a different time range for data samples of the training dataset used, and each different temporal weighting decay rate applies a different decay rate which progressively reduces the impact of each data sample on the training of the AI model the less recent the data sample;
h. evaluating performance of said plurality of candidate training datasets using model simulations trained on each of said candidate training datasets and tested against a benchmark dataset; and
i. selecting the candidate training dataset with the combination of temporal window and temporal weighting decay rate that yields the highest performance in said evaluation for retraining said AI model, and
j. retraining the AI model with the selected candidate training dataset.

Optionally, the further training dataset comprises a combination of data samples from the first training dataset and data samples generated from subsequent operation of the system after the AI model was trained on the first training dataset.

Optionally, the method further comprises analysing said data samples from the first training dataset to detect any samples subject to an above-threshold amount of covariate shift relative to the input data; and removing from the further training dataset those detected samples that exceed the above-threshold amount of covariate shift.

Optionally, the statistical value in step b is computed using an L-infinity norm process.

Optionally, the L-infinity norm process is applied on a data sample-by-data sample basis, comparing each data sample of the input data to corresponding data samples in the first training dataset.

Optionally, each different temporal weighting decay rate corresponds to a different exponential decay curve.

Optionally, the output prediction data comprises classification data associated with a predicted classification of a property of the input data.

Optionally, the input data is associated with financial transaction data.

Optionally, the input data comprises data relating to one or more of: invoices, receipts, purchase orders, quotations, contracts, bank statements, credit memos, debit notes, financial reports, expense reports, billing statements, payroll records, and tax forms.

Optionally, the predicted classification relates to financial accounting classifications.

Optionally, the predicted classification comprises assigning a General Ledger (GL) code.

In accordance with a second aspect of the invention, there is provide a computer implemented system for covariate drift correction. The system comprises a covariate drift detection unit and a model retraining module. The covariate drift detection unit configured to: receive input data intended for an AI model; apply a covariate shift detection process to said input data, wherein said covariate shift quantification process comprises computing a statistical value to quantify the drift in said input data relative to a first training dataset on which the AI model was trained; compare said statistical value with a predetermined threshold; determine that a covariate shift has occurred when said statistical value exceeds said predetermined threshold; and trigger the model retraining module in response to said determination that a covariate shift has occurred, wherein, upon triggering. The model retraining module is configured to retrieve a further training dataset comprising at least training data based on input data and prediction data from operation of the system after the first training dataset was generated; generate from the further training dataset a plurality of candidate training datasets, each generated by applying to the further training dataset a different combination of different temporal windows and different temporal weighting decay rates, wherein each different temporal window specifies a different time range for data samples of the training dataset used, and each different temporal weighting decay rate applies a different decay rate which progressively reduces the impact of each data sample on the training of the AI model; evaluate performance of said plurality of candidate training datasets using model simulations trained on each of said candidate training datasets and tested against a benchmark dataset; select the candidate training dataset with the combination of temporal window and temporal weighting decay rate that yields the highest performance in said evaluation for retraining said AI model, and retrain the AI model with the selected candidate training dataset.

Optionally, the further training dataset comprises a combination of data samples from the first training dataset and data samples generated from operation of the AI model after being trained on the first training dataset.

Optionally, the model retraining module is further configured to: analyse said data samples from the first training dataset to detect any samples subject to an above-threshold amount of covariate shift relative to the input data; and remove from the further training dataset those detected samples that exceed the above-threshold amount of covariate shift.

Optionally, the statistical value is computed by the covariate drift detection unit 102 using an L-infinity norm process.

Optionally, the L-infinity norm process is applied on a data sample-by-data sample basis, comparing each data sample of the input data to corresponding data samples in the first training dataset.

Optionally, each different temporal weighting decay rate corresponds to a different exponential decay curve.

Optionally, the output prediction data comprises classification data associated with a predicted classification of a property of the input data.

Optionally, the input data is associated with financial transaction data.

Optionally, the input data comprises data relating to one or more of: invoices, receipts, purchase orders, quotations, contracts, bank statements, credit memos, debit notes, financial reports, expense reports, billing statements, payroll records, and tax forms.

Optionally, the predicted classification relates to financial accounting classifications.

Optionally, the predicted classification comprises assigning a General Ledger (GL) code.

In accordance with certain embodiments of the invention, a technique is provided for updating an AI model when an above-threshold amount of covariate drift in the input data is detected. However, unlike conventional techniques, the retraining process includes additional steps that fine-tune the model for optimal resilience against future concept drift.

Specifically, the invention employs an approach to retraining that involves generating multiple candidate training datasets. Each set combines original training data with supplemental data collected during system operation. These datasets differ in two key parameters: temporal window size and temporal weighting decay rate. The temporal window size refers to the time range over which new data samples are included in each training set. The temporal weighting decay rate specifically reduces the impact of older data samples on model training, making them less influential as they age. By testing various sets defined by these different combinations, the invention identifies the one that offers the best resilience against future shifts in data, known as concept drift.

This enables the AI model to not just adapt to current changes, but also to be better prepared for future shifts in the data it processes. Importantly, every time the model is retrained using this technique, it minimises the potential impact of future concept drift. This means that the need for a more fundamental—and resource-intensive—update to the model can be delayed for a longer period. Consequently, this invention provides a more robust and adaptable AI system, particularly useful for applications like invoice processing, where data attributes can change over time.

Various further features and aspects of the invention are defined in the claims.

### BRIEF DESCRIPTION OF THE DRAWINGS

Embodiments of the present invention will now be described by way of example only with reference to the accompanying drawings where like parts are provided with corresponding reference numerals and in which:

FIG. 1 provides a simplified schematic diagram depicting an example of a system arranged in accordance with certain embodiments of the invention;

FIG. 2 depicts a process flow performed by the system shown in FIG. 1, highlighting how an AI model is automatically retrained when an above-threshold level of covariate drift is detected;

FIG. 3 shows a process flow performed by the system depicted in FIG. 1, detailing the steps for retraining the AI model;

FIG. 4 provides a simplified schematic diagram depicting components of a model retraining module arranged in accordance with certain embodiments of the invention;

FIG. 5 illustrates the generation of a plurality of candidate training datasets in accordance with certain embodiments of the invention, and

FIG. 6 provides a simplified schematic diagram depicting an example implementation of a system arranged in accordance with certain embodiments of the invention.

### DETAILED DESCRIPTION

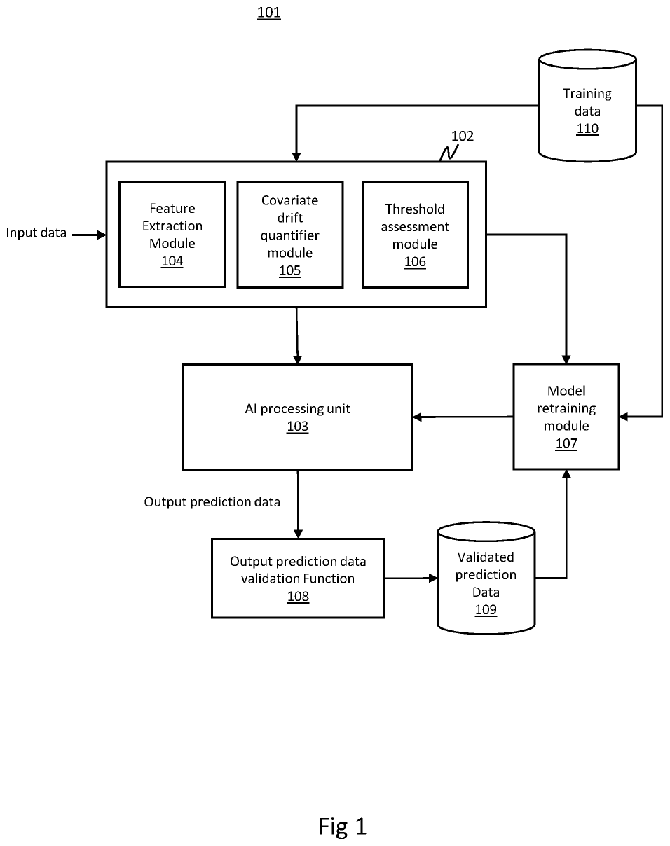

FIG. 1 provides a simplified schematic diagram depicting a system 101 arranged in accordance with certain embodiments of the invention in which an AI model is used to generate prediction data based on received input data.

In typical examples, the prediction data is some form of classification data associated with a predicted classification of a property of the input data.

For example, the input data might be financial transaction data such as invoice data received from an accounting software application, and the prediction data generated by the AI model maybe a general ledger (GL) code which the AI model, having been trained on training data, predicts is associated with the invoice to which the invoice data relates. In such an example, the system 101 might be integrated into a larger system for providing accounting and services such as accounts payable and accounts receivable functions.

In typical examples, once output, the prediction data is then validated (for example a user manually indicates whether or not a predicted GL code has been correctly identified) and the input data and the validated prediction data is stored for the purposes of periodic model retraining.

This periodic model retraining enables the system 101 to account for covariate drift.

Retraining of the AI model will typically occur at set predetermined time intervals. However, as explained in more detail below the system 101 comprises further functionality which identifies if covariate drift may have occurred in the input data which necessitates more immediate retraining of the AI model.

Specifically, the system 101 comprises a covariate drift detection unit 102 connected to an AI processing unit 103 which implements the AI model.

The technique is broadly applicable to any suitable type of AI model, for example, Large Language Models (LLMs), Convolutional Neural Networks (CNNs), Recurrent Neural Networks (RNNs), Generative Adversarial Networks (GANs), Decision Trees, Random Forests, Graph Neural Networks (GNNs), Deep Reinforcement Learning Models, Transformer Models beyond LLMs (such as Vision Transformers), specialized Time Series Models like Long Short-Term Memory (LSTM) and Gated Recurrent Units (GRU), and various Hybrid Models combining different AI approaches.

The covariate drift detection unit 102 comprises a feature extraction module 104, a covariate drift quantifier module 105 and a threshold assessment module 106.

The system 101 further comprises a model retraining module 107 and an output prediction data validation function 108. The system 101 also comprises a validated prediction data database 109 and a training data database 110. Training data on which the AI model has been trained is stored in the training data database 110.

The output prediction data validation function 108 is connected to the output of the AI processing unit 103 and is configured to write data to the validated prediction data database 109. Validated prediction data, used for updating the training of the AI model is stored in the validated prediction data database 109.

The model retraining module 107 is configured to access data from both the validated prediction data database 109 and training data database 110. The covariate drift detection unit 102 is also configured to access data stored on the training data database 110.

In use, the covariate drift detection unit 102 receives the input data, processes it to determine whether or not it has been subject to a degree of covariate shift relative to training data used to train the AI model used by the AI processing unit 103, which exceeds a predetermined threshold.

If such a covariate shift is not detected, generation of prediction data continues otherwise conventionally, and the input data is forwarded to the AI processing unit 103 to generate prediction data. This prediction data is then output by the AI processing unit 103 which is received by output prediction data validation function 108 which validates accuracy of the prediction data and then stores the validated prediction data, along with the corresponding input data in the validated prediction data database 109.

If the covariate drift detection unit 102 determines that the input data has been subject to an above-threshold degree of covariate drift, then the model training module 107 is activated which then implements a model retraining process in which the AI model running on the AI processing unit 103 is retrained.

As is explained in more detail below, the model is retrained using the validated prediction data stored in the validated prediction data database 109. This means the AI model is retrained on more “recent” data, thereby correcting for covariate drift from the original training data. In particular, a training protocol is performed that provides a model that is more resilient to “concept drift”.

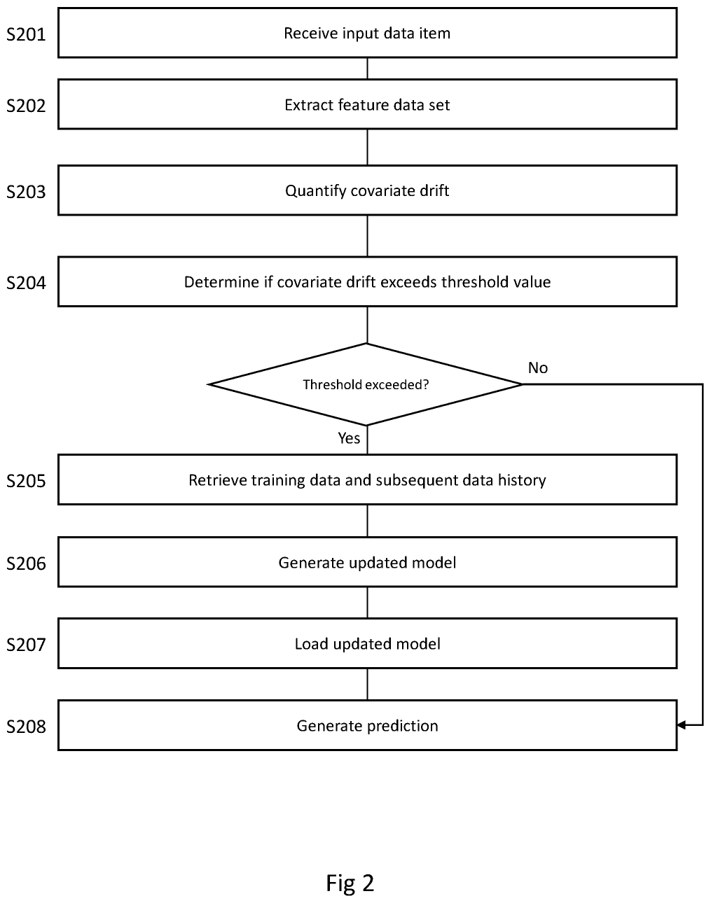

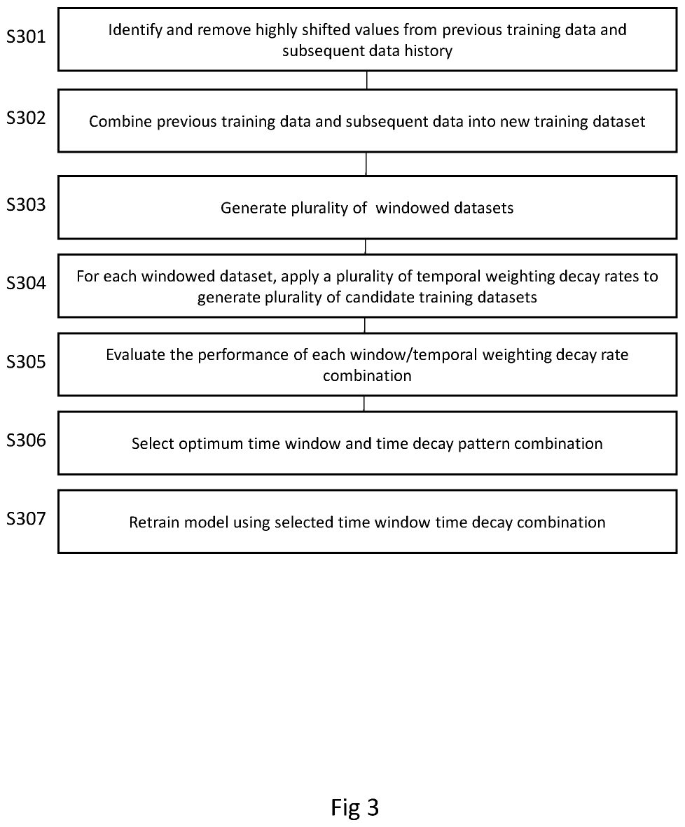

Operation of these components is now described further with reference to the flow diagrams depicted in FIG. 2 and FIG. 3.

With reference to FIG. 2, at a first step S201, the covariate drift detection unit 102 receives input data intended to be input to the AI model. This input data is typically part of a request to generate prediction data for a given input, for example, to predict the GL code associated with text data extracted from an invoice.

At a second step S202, the feature extraction module 104 of the covariate drift detection unit 102 processes the input data to extract from it a feature dataset. This feature dataset comprises a collection of data samples corresponding to quantifiable attributes or characteristics relevant to the input data. In the context of text data from an invoice, this may include one or more elements such as keywords, keyword frequency, specific numerical or textual patterns, and invoice format structures.

The feature extraction module 104 will typically be configured in accordance with the type of input data being processed by the system 101. For example, if the input data is text data, the feature extraction module 104 may use natural language processing techniques. These techniques include tokenization, where the text is split into words or phrases, and part-of-speech tagging to identify the grammatical roles. Additionally, named entity recognition may be employed to identify and categorize key information such as dates, amounts, or company names within the text.

The feature extraction module 104 then passes this feature data to the covariate drift quantifier module 105.

At a third step S203, the covariate drift quantifier module 105 is configured to perform a covariate drift quantification process to analyse the extracted feature dataset with reference to the training data stored in the training data database 110. This process quantifies a degree of covariate drift between this feature dataset and corresponding features datasets training dataset on which the AI model was most recently trained.

To do this, the covariate drift quantifier module 105 uses an appropriate statistical technique to compute a covariate drift value which is a statistical value which quantifies a degree of covariate drift between the extracted feature dataset of the input data relative to the corresponding feature dataset of the training dataset.

As the skilled person will understand, the statistical technique, can be any appropriate technique that allows covariate drift to be quantified.

In certain examples, the statistical technique is achieved using an L infinity norm-based technique. Specifically, the L infinity norm is calculated for the extracted feature dataset to identify the maximum absolute deviation from the corresponding features in the training dataset. This L infinity norm value serves as the covariate drift value. To implement this, in typical examples, the L-infinity norm process is applied on a data sample-by-data sample basis, comparing each data sample of the extracted feature dataset of the input data to corresponding data samples in the first training dataset.

The covariate drift quantifier module 105 then passes the covariate drift value to the threshold assessment module 106 which at fourth step S204 determines if the covariate drift value exceeds a covariate drift threshold value.

The covariate drift threshold value is typically a predetermined value which can be set in any suitable way. For example, in certain examples, the covariate drift threshold value can be set based on empirical analysis, using historical data to identify a level where drift indicates significant changes in data patterns that warrant retraining. In other examples, the threshold can be established using a statistical approach. For example, it might be determined as a specific number of standard deviations away from a mean of the training data's feature datasets, or it could be based on a percentile ranking within the distribution of historical feature data values.

If the covariate drift threshold value is not exceeded, the process proceeds to the eighth step S208 where the input data is passed to the AI processing unit 103 which then generates and outputs corresponding prediction data.

This output prediction data is typically then received by the output prediction data validation function 108 which performs a validation process on the output prediction data in which the correctness of the output prediction data is validated. This can be achieved in any suitable way. For example, the validation can be performed in real-time by obtaining user feedback on the accuracy of the predictions, where users confirm or correct the output data as part of their interaction with the system. Alternatively, validation can be conducted offline through bulk analysis, where batches of prediction data are periodically reviewed and validated against known accurate datasets or through expert review.

Validated prediction data generated by the output prediction data validation function 108, along with the corresponding input data, is then stored in the validated prediction data database 109 for use in model retrained as described below.

Returning to the operation of the threshold assessment module 106, if the predetermined covariate drift threshold value is exceeded, the threshold assessment module 106 then triggers the model retraining module 107 to perform a model retraining process in which the AI model of the AI processing unit 103 is retrained using the validated prediction data stored in the validated prediction data database 109.

To perform this process, at a fifth step S205 the model retraining module 107 retrieves the validated prediction data and corresponding input data stored in the validated prediction data database 109 along with the original training data stored in the training data database 110. As will be understood, this validated prediction data forms training data based on input data and corresponding prediction data from operation of the system after the training dataset used to train the current AI model was generated.

At a sixth step S206, the model retraining module 107 executes a training protocol that generates an updated AI model using a combination of the original training data from the training data database 110 and the subsequently generated validated prediction data and corresponding input data stored in the validated prediction data database 109. This training protocol is explained in more detail with reference to FIG. 3.

At a seventh step S207, the updated model is loaded from the model retraining module 107 to the AI processing unit 103.

The process then moves to the final step S208 in which the input data which triggered the model retraining is then input to the AI processing unit 103 and prediction data is generated by the updated AI model operating on the AI processing unit 103. As the skilled person will appreciate, the execution of step S208 is adaptable based on the system's operational needs. In certain implementations, the processing of data in step S208 might precede model retraining, especially when real-time retraining is not practical.

FIG. 3 depicts an example model retraining protocol which can be executed by the model retraining module 107 in accordance with certain embodiments of the invention and in particular when the threshold assessment module 106 has determined that the covariate shift value has exceeded the predetermined threshold.

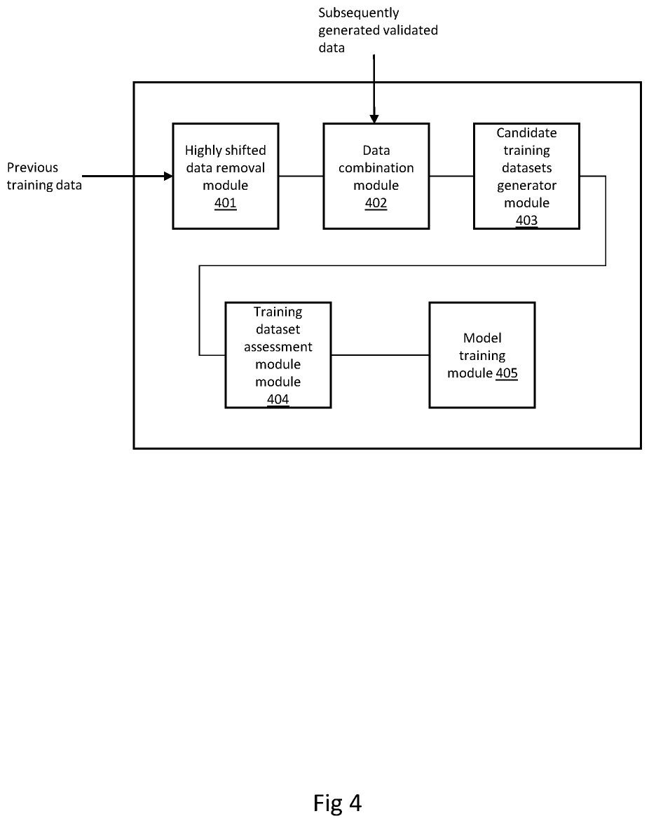

FIG. 4 provides a simplified schematic diagram depicting in more detail components of the model retraining module 107 in accordance with certain embodiments of the invention for performing the example model retrained protocol depicted in FIG. 3. As can be seen from FIG. 4, the model retraining module 107 comprises a data removal module 401 which is connected to a data combination module 402 which in turn is connected to a candidate training dataset generating module 403. The candidate training dataset generating module 403 is in turn connected to a training dataset assessment module 404 which is connected to a model training module 405.

When the model retraining module 107 is triggered, the model retraining module 107 implements the process shown in FIG. 3.

Specifically, at a first step S301, the data removal module 401 retrieves the original model training dataset from the training data database 110, analyses data samples from this dataset to detect any data samples subject to an above-threshold amount of covariate shift relative to the input data and then removes them.

The data removal module 401 can do this in any suitable way. For instance, the removal of data points could be performed using an L infinity norm-based technique. In this approach, the L infinity norm is calculated for each data point in the original training set by comparing it to the feature values of the subsequently collected datasets stored in the validated prediction data database 109.

Specifically, the L infinity norm identifies the maximum absolute difference between corresponding features of each old training data point and the typical or average features of the subsequently collected dataset. These L infinity norm values are then compared against a predetermined threshold set for indicating a high degree of covariate shift. Data points that have an L infinity norm value exceeding this threshold are removed from the original training dataset, as they are considered to have undergone significant covariate shift.

At a second step S302, the data removal module 401 passes on the previous training dataset, with the highly shifted data removed to the data combination module 402. The data combination module 402 retrieves the subsequently generated validated prediction data from the validated prediction data database 109 and combines this with the dataset received from the data removal module 401.

In certain examples, most or even all of the original training dataset may be rejected and therefore the process may continue using only a further training dataset formed mostly or exclusively from the subsequently collected validated prediction data and corresponding input data.

However, in typical examples, not all of the original training set will be rejected, and the further training dataset comprises a combination of data samples from the first training dataset and data samples generated from subsequent operation of the system after the AI model was trained on the first training dataset.

The training data and the validated prediction data and corresponding input data are typically stored in the training data database 110 and validated prediction data database 109 respectively with a time data record indicating a point in time at the data was collected. This facilitates the next steps of the model retraining process in which a number of candidate training datasets are generated by the candidate training dataset generating module 403.

Specifically, as set out below, each candidate training dataset is tested by the training dataset assessment module 404, and the candidate training set that produces the optimum results is then selected for retraining the AI model used. This retraining is performed by the model training module 405. Each candidate training dataset is generated using a different combination of temporal windowing (the time range of data samples used) and temporal weighting decay rate (a weighting which decays the older a data sample is so that the more recent a data sample, the greater effect it has on the model training and conversely, progressively reduces the impact of each data sample on the training of the AI model the less recent the data sample).

Accordingly, at a third step S303, the candidate training dataset generating module 403 receives the combined data from the data combination module 402 and generates from this data a plurality of temporally “windowed” datasets. Each “windowed” dataset contains data from the training data and the validated prediction data that fall within a specified time range of each temporal window.

At a fourth step S304, for each windowed dataset, the candidate training dataset generating module 403 generates a plurality of further datasets, each of which have a different temporal weighting decay rate applied to them. This results in a plurality of candidate training datasets each of which have a unique combination of temporal window and temporal weighting decay rate.

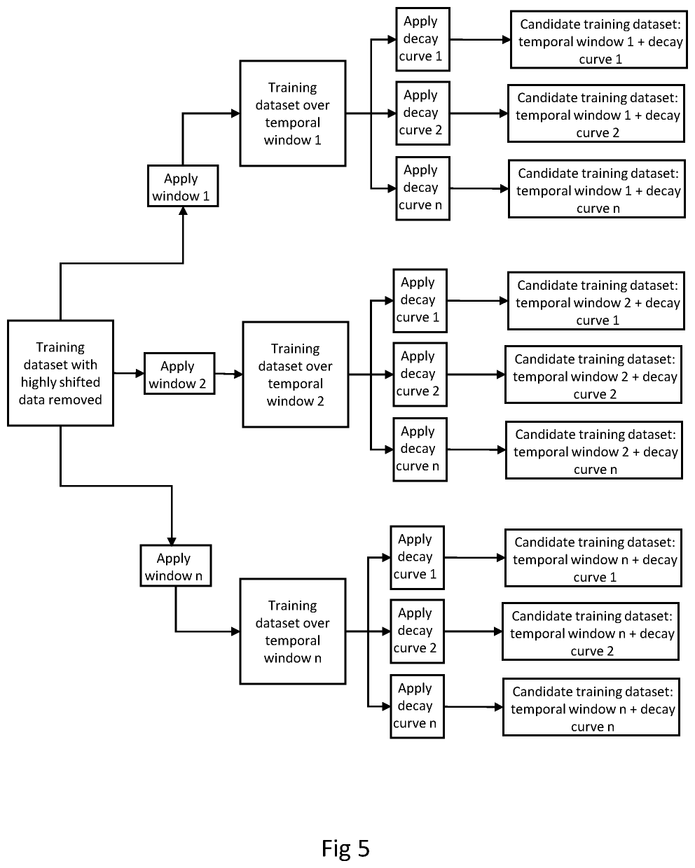

This concept is depicted in FIG. 5 which depicts an initial training dataset with the highly shifted data removed (in accordance with the first step S301) having several different temporal windows applied (in accordance with the third step S303) generating a plurality of training datasets with different temporal windows, and then for each of these datasets, applying one of a plurality of different decay curves (in accordance with the fourth step S304), to generate a final plurality of candidate training dataset.

The temporal weighting decay rate can be applied in any suitable way using any suitable mathematical technique. In one example, each different temporal weighting decay rate corresponds to a different exponential decay curve, that is an exponential decay curve with a different decay constant.

At a fifth step S305, the training dataset assessment module 404 receives the candidate training datasets from the candidate training dataset generating module 403 and evaluates the performance of each training dataset.

To evaluate the performance of each candidate training dataset, a model simulation is trained on each candidate training dataset and then tested using a benchmark dataset. The benchmark dataset may include a mix of training data, subsequent data, and other independent data samples that have not been used in any previous model training.

Typically, various performance metrics such as accuracy, precision, and recall are computed for each simulation. The candidate training dataset whose model simulation yields the highest performance according to these metrics is then identified by the training dataset assessment module 404 and selected for retraining the AI model used in the AI processing unit 103.

This approach means that a combination of a specific temporal window and exponential decay rate that provides maximal resilience against concept drift can be identified and deployed. More specifically, by fine-tuning these two parameters in tandem, the model can be better equipped to handle shifts in the underlying data distribution, thereby enhancing its ability to adapt to new scenarios and maintain high performance over time.

Accordingly, at a six step, S306 the training dataset assessment module 404 identifies the candidate training dataset which produced the optimum performance, in other words the candidate training dataset with the combination of temporal window and temporal weighting decay rate that yields the highest performance, and at a seventh step S307, the AI model is retrained by the model training module 405 using this selected candidate training dataset.

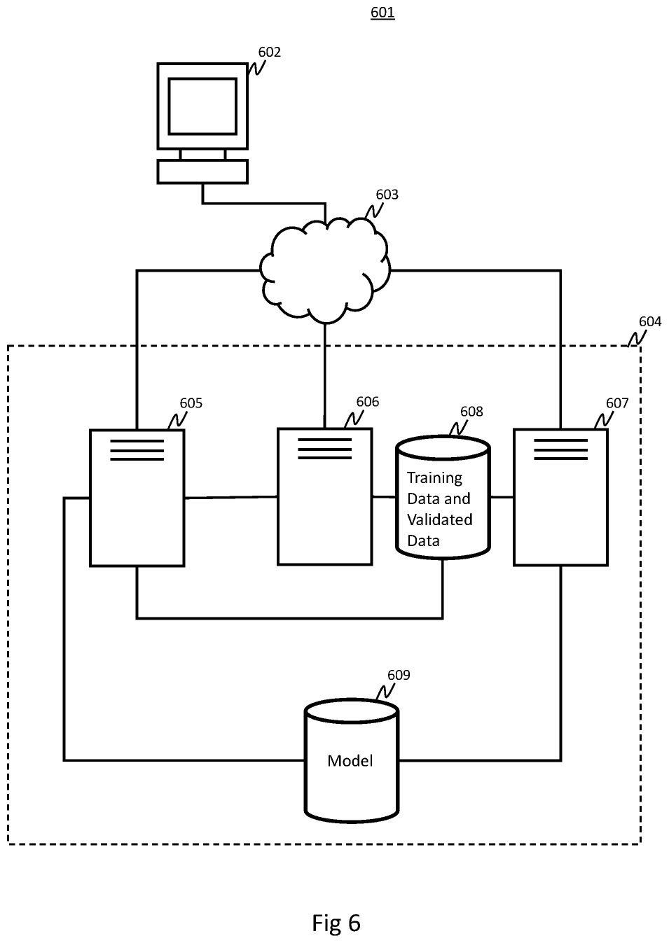

As the skilled person will understand, the system depicted in FIG. 1 and the techniques described with reference to FIGS. 2 and 3 can be implemented in any suitable way. An example implementation of an example of the invention is shown in FIG. 6.

FIG. 6 provides a simplified schematic diagram of a system 601 comprising a user computing device 602 on which is running client software, for example web browsing software, which provides an interface via which input data can be provided and prediction data received. This architecture, as illustrated, is intended to represent a typical implementation of an enterprise-level software application. Specifically, it is suited for providing accounting services to multiple users or organizations. While FIG. 5 depicts a single user computing device 602, it is important to note that in typical implementations of an enterprise-level application, there would be many such devices simultaneously accessing and using the services provided by the system.

This input data (for example text data extracted from an invoice) is communicated via a network 603 to a data processing system 604 which is configured to process the input data to produce prediction data (for example a predicted GL code) which is then returned to the client software running on the user computing device 602.

The data processing system 604 comprises three computing units: a first computing unit 605, a second computing unit 606 and a third computing unit 607. Each computing unit is connected to a first data storage unit 608 on which the training data database 110 and validated prediction data database 109 are implemented. The first computing unit 605 and third computing unit 607 are connected and a second data storage unit 609 on which model data defining the AI model is stored.

The first computing unit 605 has running thereon functionality which implements the AI processing unit 103 (which runs the AI model) and the output prediction data validation function 108, the second computing unit 606 has running thereon functionality which implements the covariate drift detection unit 102 and the third computing unit 607 has running thereon functionality which implements the model retraining module 107.

In use, the second computing unit 606 receives the input data from the user computing device 602 and the covariate drift detection unit 102 detects whether or not an above-threshold degree of covariate shift has occurred. As described above, this is done with reference to the training data which is stored in the first data storage 608.

If such covariate drift is not detected, the AI processing unit 103 running on the first computing unit 605 is activated and receives the input data sent from the user computing device 602. The AI processing unit 103 performs any necessary pre-processing operations (for example if the input data comprises text data, normalising and tokenising the text data). The AI processing unit 103 then loads relevant model data from the second data storage 609 and applies the pre-processed data to the loaded model to generate the prediction data (e.g. a predicted GL code). This prediction data is then communicated back to the client software running on the user computing device 602. The prediction data is also passed to the output prediction data validation function 108 which validates whether the output prediction data was correct. The output prediction data validation function 108 can operate in any suitable way. In a typical example, it may communicate a validate query to the software running on the user computing device 602 prompt a user to manually confirm if the prediction data was accurate. For example, if the GL code associated with an input invoice has been correctly predicted. One the prediction data has been validated in this way, it is then stored in the validated prediction data database 109 running on the first data storage 608 with an appropriate time stamp for facilitating the temporal windowing described above.

If the covariate drift detection unit 102 running on the second computing unit 606 determines that an above-threshold degree of covariate drift has occurred, the model retraining module 107 running on the third computing unit 607 is activated. As described above, the model training process described with reference to FIG. 3 is run in which the original training data and the subsequently generated validated prediction data stored in the first data storage 608 is retrieved and used to retrain an updated model. When this is complete, the model retraining module 107 writes the updated model data to the second data storage 609.

The implementation of an example of the invention described with reference to FIG. 6 is merely illustrative and it should be understood that various changes, substitutions, and alterations can be made in alternative embodiments.

For example, the functionality provided by the covariate drift detection unit 102, AI processing unit 103, model retraining module 107 and output prediction data validation function 108 can be integrated into larger systems, including but not limited to systems providing comprehensive accounting services. These functions can operate on the described computing devices, or additional computing devices, tailored to the needs of such larger systems.

The hardware implementation shown in FIG. 6, while described as a distinct configuration of computing units and data storage units, is merely illustrative. The invention can be deployed in various hardware setups, ranging from a singular, compact device to a distributed system spanning multiple devices. In regard to data storage aspects, the databases can be implemented using any suitable database technology, influenced by factors such as data volume, security requirements, and access speed, among others, and with which the skilled person will be familiar. As the skilled person will understand, the network 603 connecting the user device to the data processing system, although typically provided by the internet, can be substituted with any suitable network infrastructure that supports the required data transmission and system functionality. In the example illustrated in FIG. 5, the user computing device 602 is shown as remote from the data processing system 604. This configuration depicts a scenario where the input data is communicated from a user's device to a separate data processing system via a network. However, in alternative embodiments, the functions associated with the data processing system 604 can be implemented partially or wholly locally at the user computing device 602. Regarding user interaction with the system, the user device 602 is not limited to a specific type. Devices such as tablets, phones, laptops, or any other suitable computing device, including those forming part of a network of interconnected computers, can be used to interface with the system. As the skilled person will understand, the core functionalities of the invention, including the covariate drift detection unit 102, AI processing unit 103, model retraining module 107, and output prediction data validation function 108, can be implemented using various software development and deployment techniques. These include coding in languages such as Python, Java, or C++, and deploying on different platforms, from on-premises servers to cloud-based systems. The software architecture might range from monolithic designs to microservices and could use containerisation technologies like Docker for enhanced portability.

As the skilled person will understand, embodiments of the invention will not be limited to handling text-based input and output data. Embodiments of the technique could relate to input data derived from any suitable source such as machine vision, sound recordings, sensor readings, geospatial information, and even biometric data. Similarly, the output of the model could be not only text-based classifications but also numerical predictions, categorical labels, or more complex data structures.

While the primary focus of this invention has been described in the context of feature data extracted from invoices and predicting General Ledger (GL) codes, it should be understood that embodiments of the invention are not limited to this specific application. The technique can also classify other properties of the input data. For instance, it might classify the risk level associated with a financial transaction or identify the type of service rendered based on the invoice details. Furthermore, the method can be applied to a broader range of financial transaction data. This includes but is not limited to bank transactions, credit card transactions, and other forms of revenue or expense recording.

The invention is adaptable to various types of financial documents, including but not limited to invoices, receipts, purchase orders, quotations, contracts, bank statements, credit memos, debit notes, financial reports, expense reports, billing statements, payroll records, and tax forms. For each of these document types, feature data can be extracted and processed in a manner similar to that described for invoice data. Moreover, the invention can predict different types of financial accounting classifications, extending beyond GL codes to include categories like expense categories, cost centres, or project codes, among others. This adaptability makes the invention robust and widely applicable across various scenarios and types of financial data.

While the invention has been primarily described in the context of invoice data processing and financial accounting, the technique can be uses in other “continuous” AI systems in which the model is in constant operation, continually receiving new data and possibly adjusting its predictions or classifications accordingly.

For example, in the field of video classification, input data to an AI model might be video data, and the output prediction data would involve classifying objects present in the video. In situations where the model encounters video data featuring objects that were not part of its training data, this would be identified as a covariate shift. The invention would then facilitate the retraining of the model to include this new type of data, thereby maintaining its effectiveness with varied video inputs. Another implementation example is in the domain of disease outbreak prediction. In this scenario, the AI model is initially trained with data parameters associated with known diseases. When the model encounters data that suggests a disease not covered in its training set, this is recognized as a covariate drift. Following the detection of such drift, the model is updated to include data related to this new disease, thus expanding its knowledge base for future predictions.

More generally, embodiments of the invention could be employed in various sectors, including real-time healthcare monitoring, financial fraud detection, supply chain management, energy consumption prediction, customer behaviour analysis in e-commerce, natural language processing, predictive maintenance, traffic management in smart cities, environmental monitoring, and social media analysis. In all these different applications, the invention offers a robust way to maintain high model performance, even when the input data changes over time.

All of the features disclosed in this specification (including any accompanying claims, abstract and drawings), and/or all of the steps of any method or process so disclosed, may be combined in any combination, except combinations where at least some of such features and/or steps are mutually exclusive. Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features. The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

It will be appreciated that various embodiments of the present disclosure have been described herein for purposes of illustration, and that various modifications may be made without departing from the scope of the present disclosure. Accordingly, the various embodiments disclosed herein are not intended to be limiting, with the true scope being indicated by the following claims.

1. A computer implemented method for covariate drift correction in a system that employs an Al model trained on a first training dataset for generating output prediction data, the method comprising:
a. receiving input data intended for said AI model;
b. applying a covariate shift quantification process to said input data, wherein said covariate shift quantification process comprises computing a statistical value to quantify the drift in said input data relative to said first training dataset;
c. comparing said statistical value with a predetermined threshold;
d. determining that a covariate shift has occurred when said statistical value exceeds said predetermined threshold; and
e. triggering a retraining process for said AI model in response to said determination that a covariate shift has occurred, wherein the retraining process comprises the steps of:
f. retrieving a further training dataset comprising at least training data based on input data and prediction data from operation of the system after the first training dataset was generated;
g. generating from the further training dataset a plurality of candidate training datasets, each generated by applying to the further training dataset a different combination of different temporal windows and different temporal weighting decay rates, wherein each different temporal window specifies a different time range for data samples of the training dataset used, and each different temporal weighting decay rate applies a different decay rate which progressively reduces the impact of each data sample on the training of the AI model the less recent the data sample;
h. evaluating performance of said plurality of candidate training datasets using model simulations trained on each of said candidate training datasets and tested against a benchmark dataset; and
i. selecting the candidate training dataset with the combination of temporal window and temporal weighting decay rate that yields the highest performance in said evaluation for retraining said AI model, and
j. retraining the AI model with the selected candidate training dataset.

2. A method according to claim 1, wherein the further training dataset comprises a combination of data samples from the first training dataset and data samples generated from subsequent operation of the system after the AI model was trained on the first training dataset.

3. A method according to claim 2, wherein the method further comprises:
analysing said data samples from the first training dataset to detect any samples subject to an above-threshold amount of covariate shift relative to the input data; and
removing from the further training dataset those detected samples that exceed the above-threshold amount of covariate shift.

4. A method according to claim 1, wherein the statistical value in step b is computed using an L-infinity norm process.

5. A method according to claim 4, wherein the L-infinity norm process is applied on a data sample-by-data sample basis, comparing each data sample of the input data to corresponding data samples in the first training dataset.

6. A method according to claim 1, wherein each different temporal weighting decay rate corresponds to a different exponential decay curve.

7. A method according to claim 1, wherein the output prediction data comprises classification data associated with a predicted classification of a property of the input data.

8. A method according to claim 1, wherein the input data is associated with financial transaction data.

9. A method according to claim 8, wherein the input data comprises data relating to one or more of: invoices, receipts, purchase orders, quotations, contracts, bank statements, credit memos, debit notes, financial reports, expense reports, billing statements, payroll records, and tax forms.

10. A method according to claim 8, wherein the predicted classification relates to financial accounting classifications.

11. A method according to claim 10, wherein the predicted classification comprises assigning a General Ledger (GL) code.

12. A computer system for covariate drift correction, said system comprising a covariate drift detection unit and a model retraining module, said covariate drift detection unit configured to:
receive input data intended for an AI model;
apply a covariate shift detection process to said input data, wherein said covariate shift quantification process comprises computing a statistical value to quantify the drift in said input data relative to a first training dataset on which the AI model was trained;
compare said statistical value with a predetermined threshold;
determine that a covariate shift has occurred when said statistical value exceeds said predetermined threshold; and
trigger the model retraining module in response to said determination that a covariate shift has occurred, wherein, upon triggering, the model retraining module is configured to:
retrieve a further training dataset comprising at least training data based on input data and prediction data from operation of the system after the first training dataset was generated;
generate from the further training dataset a plurality of candidate training datasets, each generated by applying to the further training dataset a different combination of different temporal windows and different temporal weighting decay rates, wherein each different temporal window specifies a different time range for data samples of the training dataset used, and each different temporal weighting decay rate applies a different decay rate which progressively reduces the impact of each data sample on the training of the AI model;
evaluate performance of said plurality of candidate training datasets using model simulations trained on each of said candidate training datasets and tested against a benchmark dataset;
select the candidate training dataset with the combination of temporal window and temporal weighting decay rate that yields the highest performance in said evaluation for retraining said AI model, and
retrain the AI model with the selected candidate training dataset.

13. A system according to claim 12, wherein the further training dataset comprises a combination of data samples from the first training dataset and data samples generated from operation of the AI model after being trained on the first training dataset.

14. A system according to claim 13, wherein the model retraining module is further configured to:
analyse said data samples from the first training dataset to detect any samples subject to an above-threshold amount of covariate shift relative to the input data; and
remove from the further training dataset those detected samples that exceed the above-threshold amount of covariate shift.

15. A system according to claim 14, wherein the statistical value is computed by the covariate drift detection unit 102 using an L-infinity norm process.

16. A system according to claim 15, wherein the L-infinity norm process is applied on a data sample-by-data sample basis, comparing each data sample of the input data to corresponding data samples in the first training dataset.

17. A system according to claim 13, wherein each different temporal weighting decay rate corresponds to a different exponential decay curve.

18. A system according to claim 13, wherein the output prediction data comprises classification data associated with a predicted classification of a property of the input data.

19. A system according to claim 13, wherein the input data is associated with financial transaction data.

20. A system according to claim 19, wherein the input data comprises data relating to one or more of: invoices, receipts, purchase orders, quotations, contracts, bank statements, credit memos, debit notes, financial reports, expense reports, billing statements, payroll records, and tax forms.

21. A system according to claim 18, wherein the predicted classification relates to financial accounting classifications.

22. A system according to claim 21, wherein the predicted classification comprises assigning a General Ledger (GL) code.
